(19) United States
(12) Patent Application Publication
(10) Pub. No.: US 2026/0291550 A1
(43) Pub. Date: Sep. 24, 2026

(54) OPERATING A RAN NODE THAT HAS A MIMO ANTENNA ARRAY

(71) Applicant: Telefonaktiebolaget LM Ericsson (publ), Stockholm (SE)

(72) Inventors: Takumi Yoshida, Tokyo (JP); Eito Kurihara, Tokyo (JP); Hiroki limori, Kanagawa (JP); Szabolcs Malomsoky, Kanagawa (JP); Joao Vieira, Hjärup (SE)

(21) Appl. No.: 19/473,585

(22) PCT Filed: Apr. 13, 2023
(86) PCT No.: PCT/SE2023/050347

§ 371 Date: Oct. 8, 2025

(51) Int. Cl. H04B 7/026; H04B 7/0452; H04B 7/0456; H04B 7/155

(52) U.S. Cl. CPC H04B 7/026; H04B 7/0452; H04B 7/0456; H04B 7/15507

(57) ABSTRACT

According to an aspect, there is provided a method of operating a first radio access network (RAN) node in a communication network. The first RAN node comprises a central multiple input/multiple output (MIMO) antenna array, and the communication network comprises a plurality of repeater nodes for the first RAN node. The method comprises obtaining channel information for communication channels between the central MIMO antenna array and one or more User Equipments (UEs), wherein one or more of the communication channels are via one or more of the repeater nodes; computing one or more repeater weights based on the obtained channel information, wherein the repeater weight is for adjusting a power and/or phase of signals repeated by one or more of the repeater nodes; and sending the one or more computed repeater weights to the repeater nodes.

### TECHNICAL FIELD

This disclosure relates to one or more radio access network (RAN) nodes that have a central multiple input/multiple output (MIMO) antenna array, one or more communication networks that have a number of repeater nodes, a computer program, and a computer program product.

### BACKGROUND

With the aim of ‘limitless’ connectivity in the 6th Generation (6G) era, distributed MIMO (D-MIMO, also known as “cell-free massive MIMO”, Radio Stripes, etc.) is expected to play a key role in future wireless communications systems. The fundamental idea of 6G D-MIMO is to distribute service antennas geographically over a certain service area and have them cooperate to realise joint coherent transmission (CJT) and reception from multiple access points (APs). A typical architecture is that multiple antenna panels (also termed access points (APs)) are interconnected via fronthaul links and perform phase-coherent operation. The MIMO channel resulting from such distributed antenna architectures typically yields higher spatial degrees of freedom in comparison with non-distributed/co-located MIMO scenarios. Such degrees-of-freedom can be leveraged in a number of ways, e.g., they can be exploited to 1) improve fairer signal to noise (SNR) distributions among user equipments (UEs), and 2) provide a larger number of spatially multiplexed data streams, and 3) provide larger link robustness, etc.

One of the remaining challenges with the deployment of D-MIMO systems is the fronthaul link. Fronthaul links are typically realised via a (e.g. fiber or coaxial) cable that needs to interconnect a central computing unit to multiple APs. Such fronthaul links imply significant costs in terms of manufacturing, installation, maintenance, etc. In fact, the installation of wired fronthaul links that interconnect distributed APs may in fact prove to be a major challenge for mass adoption of D-MIMO technology in, e.g., public crowded spaces (such as public squares) in the sense that it may not be convenient to dig the ground, or modify a building, in order to deploy fronthaul cables.

### SUMMARY

An alternative infrastructure setup, which has the potential to achieve similar performance gains as 6G D-MIMO but which does not require the complicated fronthaul link deployments, consists of a setup with a co-located macro massive MIMO gNB in the center of the cell, with repeaters (also referred to as repeater nodes) deployed in the coverage area of the macro gNB in cell areas requiring a boost in spectral efficiency (e.g. crowded public squares). This type of infrastructure setup is described in “Channel estimation error and beamforming performance in repeater-enhanced massive MIMO systems” by Yiming Ma, Dengkui Zhu, Boyu Li, and Ping Liang, in proc. IEEE 26th Annual International Symposium on Personal, Indoor, and Mobile Radio Communications (PIMRC), Hong Kong, China, 2015 (referred to herein as “Reference [1]”). Here, the function of the repeaters is not for coverage enhancement, but to increase the channel rank. The repeaters can have the simple form of, e.g., amplify-and-forward repeaters, where the signal is instantaneously retransmitted at the same frequency that it was received by the repeater. The repeaters, therefore, can be seen as channel scatterers but with a power gain. As in 5^{th} Generation (5G) massive MIMO, it is the massive MIMO gNB that performs all MIMO signal processing operations, and thus, in theory, minimum network upgrades are needed to realise this type of infrastructure. Since each repeater only requires access to a power source, the deployment of such repeaters is much simpler compared to the deployments of a D-MIMO network with a wired fronthaul in terms of cost of manufacturing, installation, maintenance, etc. The system model and performance gains resulting from this setup are described below.

It is assumed that one massive MIMO gNB (i.e. base station) is surrounded by multiple repeaters that are capable of reflecting and/or amplifying the signal from/to UEs located within a coverage area. A similar system model is considered in Reference [1], where those repeaters are assumed to be non-reciprocal amplify-and-forward repeaters. In contrast, these repeaters can be considered to be reciprocal, such that uplink and downlink duality of the channel through those repeaters holds; and therefore it is suitable for reciprocity-based beamforming by the common massive MIMO gNB operating in time division duplex (TDD) mode. Such reciprocal operation of repeaters can be obtained in practice in case 1) repeaters are single-antenna and thus the uplink (UL) and downlink (DL) signals travel through the same repeater RF paths, or 2) repeaters are multi-antenna and any non-reciprocities are restored via over-the-air calibration methods.

FIG. 1 shows an exemplary repeater-assisted MIMO system to which the techniques described herein can be applied. FIG. 1 shows a base station (e.g. gNB) 101 that has/is a central MIMO antenna array for a cell in the communication network. The MIMO antenna array in the base station 101 has M antennas. A number L of repeaters (repeater nodes) 102 are distributed throughout the cell, and a number K of UEs 103 are present in the cell that can communicate with the base station 101. In the following, the UEs 103 are considered to have single antennas. FIG. 1 shows that in the UL direction there can be a direct communication channel 104 from a particular UE 103 to the base station 101, and one or more indirect communication channels 105 between the particular UE 103 and the base station 101. The illustrated indirect communication channel 105 comprises a first channel part 105a from the UE 103 to a repeater 102, and a second channel part 105b from the repeater 102 to the base station 101.

In the following, the system in FIG. 1 is considered to be a synchronised uplink repeater-assisted MIMO system serving K single-antenna UEs, where a common MIMO panel/array (i.e. the BS 101) is supported by surrounding repeaters 102. It is assumed that the BS 101 is equipped with M antennas, and that L single-antenna repeaters 102 are deployed in the BS's coverage area (however it should be noted that the techniques described herein can be applied to repeaters 102 equipped with multiple antennas). The received signal at the BS 101 from the i-th UE 103 can be written as follows:

$$y = {\sum }_{i = 1}^{K} {h}_{i} {s}_{i} + n , \qquad ( 1 )$$

where sᵢ∈ [symbol] is the transmit symbol of the i-th UE 103; n∈ [symbol] ^{M} is the noise vector at the BS 101; hᵢ is the channel vector from the i-th UE 103 to the BS 101 which is composed of a non-repeated (direct) channel h̅ₖₗ 104 which can be made by the line-of-sight and/or non-line-of-sight components, and the indirect channel hₖₗ 105 through the l-th repeater 102. Moreover, the indirect propagation channel hₖₗ 105 includes

$${g}_{k l}^{U A}$$

105a which is equivalent to the propagation channel from the k-th UE 103 to the l-th repeater 102 and

$${\overline{g}}_{l}^{A B}$$

105b which is equivalent to the propagation channel from the l-th repeater 102 to the BS 101. Accordingly, the total channel from the k-th UE 103 to the BS 101 via all L repeaters 102 is defined as

$${h}_{k} = {H}_{k} η + {\overline{h}}_{k} , \qquad ( 2 )$$

where Hₖ=[hₖ₁, . . . , h_{kL}], and η=[η₁, . . . , η_{L}]^{T}∈ [symbol] ^{L} stacks the amplitude and phase responses of the repeaters 102. In the rest of this disclosure, y is referred to as the reflection vector.

It should be noted that the model above only takes into account signals arriving to the gNB 101 which are repeated at most one time after being transmitted by the UE 103. In theory, a signal can be amplified-and-forwarded an infinite number of times before being received by the gNB 101. However, for deployments where repeaters 102 are significantly far apart from one another, the path loss between repeaters 102 is larger than the repeater's gain, which means that signals that are repeated multiple times are received with significantly less power than signals that are repeated once. Thus, for simplicity, the approximation that signals are only repeated once before being received by the gNB 101 is used in this disclosure.

In order to illustrate the potential and challenges of the reflection-aided massive MIMO systems in comparison with traditional cellular (co-located) massive MIMO and state-of-the-art distributed massive MIMO systems, FIG. 2 illustrates the cumulative distribution function (CDF) of UE's signal to interference plus noise ratio (SINR), where all the simulation setups and parameters follow the ones specified in the Detailed Description section below, except for the assumption that the repeaters 102 are now considered solely as reflectors. More specifically, it is assumed in FIG. 2 that each repeater 102 can only reflect the incoming signal and may not amplify it. In FIG. 2, dashed line 201 indicates a scenario where the reciprocal repeaters 102 reflect incoming signals from UEs 103 without any phase or amplitude manipulation, solid line 202 corresponds to a traditional co-located massive MIMO system, and dashed line 203 corresponds to a fully distributed massive MIMO (i.e., cell-free) system.

As shown in FIG. 2, the fully distributed massive MIMO (i.e., cell-free) system significantly outperforms the traditional co-located massive MIMO system without assistance from surrounding repeaters. It can also be observed from FIG. 2 that the reflectors can improve the performance of the co-located massive MIMO system.

Given FIG. 2, it is observed that there is potential gain by introducing reflectors (or even more generally, reciprocal repeaters) around a co-located massive MIMO system. However, the improved gain is not sufficient to reach the performance of fully distributed massive MIMO system and therefore reflection is not enough to be alternative to distributed massive MIMO system, implying that either amplification power or phase need to be optimised, or both, at each reciprocal repeater. The techniques described herein aim to address this challenge.

As mentioned above, Reference [1] considers a co-located massive MIMO system with assistance from surrounding repeaters, but focuses its analysis on channel estimation error and its impact on reciprocity-based beamforming. Reference [1] highlighted that a repeater's non-reciprocal hardware imperfections degrade the channel estimation performance. However, Reference [1] does not provide any methodology for operating repeaters, including methods for power and phase control as well as selection of the repeaters, which potentially bring performance improvements.

An object of the invention is to enable an improvement of a performance of a MIMO system. Certain aspects of the disclosure and their embodiments may provide solutions to the above or other challenges. In particular, techniques to enable control of power and/or phase at each repeater in a cell system with a co-located massive MIMO panel are disclosed. In particular, embodiments of the techniques described herein can iteratively maximise the total SINR of signals from each UE in uplink transmission, and/or the total SINR of signals from the base station in downlink transmission (in the case of reciprocity-based beamforming and processing).

It should be noted that the type of repeater node considered hereafter can take the form of, e.g., an amplify-and-forward repeater but it could also take the form of a configurable surface, such as intelligent reflecting surface (IRS), even though this is not the primary type of repeater node that is envisioned for these techniques. This is because, in certain IRS implementations, the IRS can manipulate the amplitude and phase of the reflected signals, as discussed in “Exploiting Amplitude Control in Intelligent Reflecting Surface Aided Wireless Communication With Imperfect CSI” by Ming-Min Zhao et al., IEEE Trans. Communications, vol. 69, no. 6, June 2021 (referred to herein as Reference [2]).

Certain embodiments may provide one or more of the following technical advantage(s). An advantage of the proposed techniques can be performance improvements in SINR of each UE, which is achieved by improving or optimising the phase and/or amplification power at each connected repeater. As discussed further below, simulation results show that the performance of the disclosed techniques can offer comparable performance to the performance of distributed massive MIMO systems with wired fronthaul links. Thus, performance comparable to D-MIMO systems can be obtained using a network infrastructure with significantly less costs in terms of manufacturing, installation and maintenance, since it does not require wired fronthaul interconnections between the distributed nodes.

According to a first specific aspect of the techniques described herein, there is provided a method of operating a first radio access network, RAN, node in a communication network. The first RAN node comprises a central multiple input/multiple output, MIMO, antenna array and the communication network comprises a plurality of repeater nodes for the first RAN node. The method comprises: obtaining channel information for communication channels between the central MIMO antenna array and one or more UEs, wherein one or more of the communication channels are via one or more of the repeater nodes; computing one or more repeater weights based on the obtained channel information, wherein the repeater weight is for adjusting a power and/or phase of signals repeated by one or more of the repeater nodes; and sending the one or more computed repeater weights to the repeater nodes.

According to a second aspect, there is provided a method of communicating between a first radio access network, RAN, node and one or more user equipments, UEs. The first RAN node comprises a central multiple input/multiple output, MIMO, antenna array, and the communication network comprises a plurality of repeater nodes for the first RAN node. The method comprises: operating the first RAN node according to the first aspect or any embodiment thereof; and, in a repeater node: receiving the one or more repeater weights from the first RAN node; receiving a transmission from one of the UEs or the first RAN node; and repeating the received transmission according to the received one or more repeater weights.

According to a third aspect, there is provided a computer program product comprising a computer readable medium having computer readable code embodied therein, the computer readable code being configured such that, on execution by a suitable computer or processor, the computer or processor is caused to perform the method according to the first aspect or any embodiment thereof.

According to a fourth aspect, there is provided a first radio access network, RAN, node for use in a communication network. The first RAN node comprises a central multiple input/multiple output, MIMO, antenna array, and the communication network comprises a plurality of repeater nodes for the first RAN node. The first RAN node is configured to: obtain channel information for communication channels between the central MIMO antenna array and one or more UEs, wherein one or more of the communication channels are via one or more of the repeater nodes; compute one or more repeater weights based on the obtained channel information, wherein the repeater weight is for adjusting a power and/or phase of signals repeated by one or more of the repeater nodes; and send the one or more computed repeater weights to the repeater nodes.

According to a fifth aspect, there is provided a first radio access network, RAN, node for use in a communication network. The first RAN node comprises a central multiple input/multiple output, MIMO, antenna array, and the communication network comprises a plurality of repeater nodes for the first RAN node. The first RAN node comprises a processor and a memory, said memory containing instructions executable by said processor whereby said first RAN node is operative to: obtain channel information for communication channels between the central MIMO antenna array and one or more UEs, wherein one or more of the communication channels are via one or more of the repeater nodes; compute one or more repeater weights based on the obtained channel information, wherein the repeater weight is for adjusting a power and/or phase of signals repeated by one or more of the repeater nodes; and send the one or more computed repeater weights to the repeater nodes.

### BRIEF DESCRIPTION OF THE DRAWINGS

Some of the embodiments contemplated herein will now be described more fully with reference to the accompanying drawings, in which:

FIG. 1 shows an exemplary repeater-assisted MIMO system to which the techniques described herein can be applied;

FIG. 2 is a graph illustrating a CDF of UE's SINR;

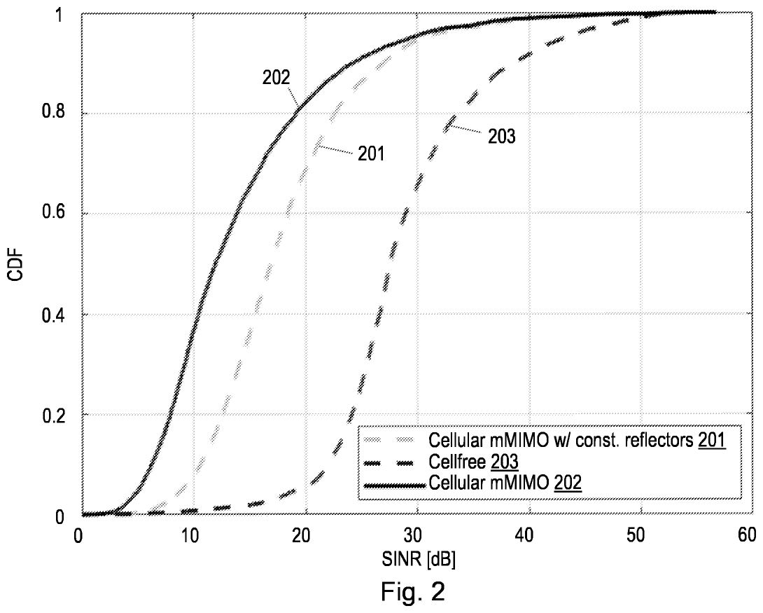

FIG. 3 is a flow chart illustrating an exemplary method for optimising power and/or phase control in repeater nodes;

FIG. 4 is a flow chart illustrating an exemplary method to iteratively optimise weights for power and/or phase at a repeater node;

FIG. 5 is a graph plotting SINR against CDF performance of a repeater-assisted MIMO system versus a cell free network and cellular MIMO;

FIG. 6 is a graph plotting SINR against CDF performance of a repeater-assisted MIMO system in a multi-cell scenario;

FIG. 7 is a flow chart illustrating a method of operating a first RAN node according to various embodiments;

FIG. 8 is a flow chart illustrating a method of operating a repeater node according to various embodiments;

FIG. 9 is a simplified block diagram of an apparatus that can implement the techniques described herein;

FIG. 10 shows an example of a communication system in accordance with some embodiments;

FIG. 11 shows a RAN network node in accordance with some embodiments;

FIG. 12 is a block diagram illustrating a virtualization environment in which functions implemented by some embodiments may be virtualized; and

FIG. 13 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

The following discussion presents the weight control mechanism for repeater-assisted MIMO systems, namely the optimisation of the reflection vector n. In the following, it is assumed that any relevant UEs are not moving fast, as is the case with conventional Frequency Division Duplex (FDD) multiple user MIMO (MU-MIMO) systems (i.e. not high mobility scenarios). Furthermore, it is assumed that the instantaneous channel state information (CSI) can be utilised to control the phase and/or power of the repeaters, which can be collected by either downlink or uplink CSI acquisition.

The problem of optimising the power and/or phase of the reflection vector 1 which is addressed by the techniques described herein is elaborated below.

Initially, each element of η is defined as:

$${η}_{l} = \sqrt{{α}_{l}} {e}^{j {ϕ}_{l}} , \qquad ( 3 )$$

where αₗ is the power gain at l-th repeater, and φₗ∈[0,2π) is the controllable phase shift at l-th repeater. In other words, it is assumed that the l-th repeater can apply a controllable gain ηₗ when repeating a signal.

Controlling the power gain, αₗ, can be performed, e.g., by adjusting the output power of the repeater.

Controlling the phase, φₗ, can be performed, e.g., by adjusting the effective travelling distance that the repeater signals travel in one or more transmission lines that exist at the radio frequency (RF) part of the repeater (e.g. with RF switches).

Considering a single cell scenario as an example, the SINR of the k-th UE is characterised by:

$${SINR}_{k} = p {{h}_{k}^{H} ( p {\sum }_{{i = 1}_{i \neq k}}^{K} {h}_{i} {h}_{i}^{H} + {σ}^{2} {I}_{M} )}^{- 1} {h}_{k} , \qquad ( 4 )$$

where p is the transmit power at UEs. With that, the sum of the SINR expressions among all uplink UEs is given by:

$${SINR}_{s y s t e m} = {\sum }_{k = 1}^{K} {SINR}_{k} = p {\sum }_{k = 1}^{K} {{h}_{k}^{H} ( p {\sum }_{{i = 1}_{i \neq k}}^{K} {h}_{i} {h}_{i}^{H} + {σ}^{2} {I}_{M} )}^{- 1} {h}_{k} . \qquad ( 5 )$$

When it comes to adjusting η such that a certain utility criterion is optimised, different utility functions may be considered that are often a function of the SINR shown in Equation (5). As an example of such design criterion, the maximisation of the sum of UEs' SINRs is considered hereafter.

To this end, the sum-SINR maximisation problem with respect to the complex vector η can be written as follows:

$${maximize}_{η} {SINR}_{s y s t e m} = {maximize}_{η} {\sum }_{k = 1}^{K} {Â}_{k}^{H} ( η ) {\hat{B}}_{k}^{- 1} ( η ) {Â}_{k} ( η ) \qquad ( 6 )$$

$$subject to \vert {η}_{l} {\vert}^{2} \leq {P}_{max} , for l = 1 , 2 , … , L \qquad ( 7 )$$

$$with$$

$${Â}_{k} ( η ) = {h}_{k} = {H}_{k} η + {\overline{h}}_{k} \qquad ( 8 )$$

$${\hat{B}}_{k} ( η ) = p {\sum }_{{i = 1}_{i \neq k}}^{K} {h}_{i} {h}_{i}^{H} + {σ}^{2} {I}_{M} = p {\sum }_{{i = 1}_{i \neq k}}^{K} ( {H}_{i} η {η}^{H} {H}_{i}^{H} + {H}_{i} η {\overline{h}}_{i}^{H} + {\overline{h}}_{i} {η}^{H} {H}_{i}^{H} + {\overline{h}}_{i} {\overline{h}}_{i}^{H} ) + {σ}^{2} {I}_{M} \qquad ( 9 )$$

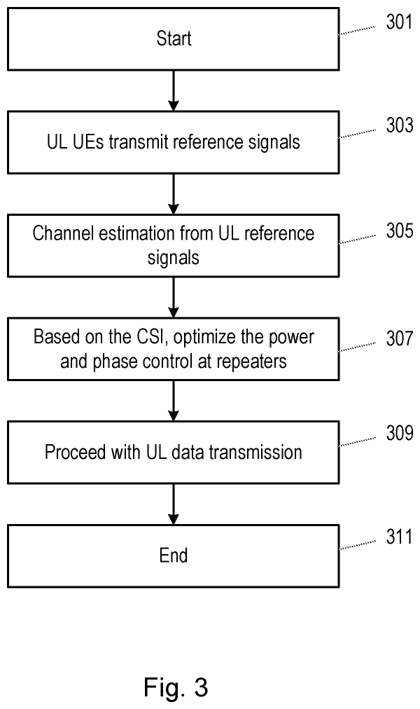

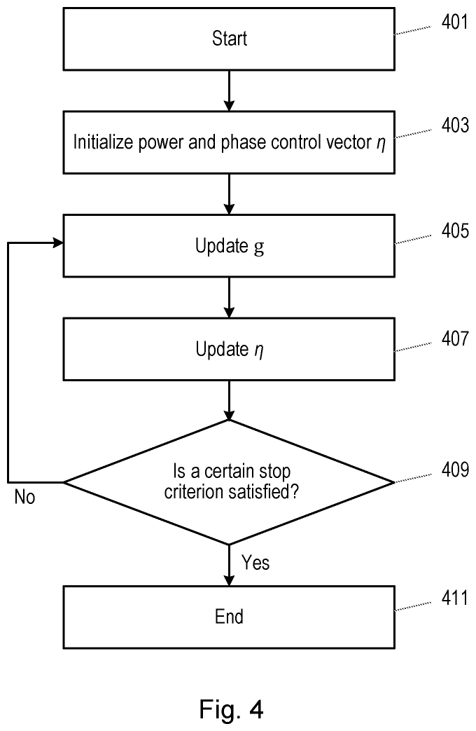

An overview of the techniques for optimising the power and/or phase weights 1 is shown in the flow charts in FIGS. 3 and 4. These methods can be performed by the BS/RAN node 101. In these methods, the power and phase weights are optimised such that a certain utility is maximised.

The main steps of the method are listed below:
301—The method is initiated/started; this can occur periodically to account for changes in channel conditions, or when channel conditions have changed by a sufficient amount.
303—Uplink UEs 103 transmit reference signals (RSs) to the gNB 101 through the activated repeaters 102 (this is known as instantaneous CSI acquisition).
305—The gNB 101 estimates CSI based on the uplink RSs.
307—Based on CSI estimates, the weights at the activated repeaters 102 are optimised such that a certain objective is optimised.
309—Data uplink/downlink transmission proceeds using the weights determined in step 307.
311—The method ends.

In an embodiment of step 307, weights can be optimised by solving the sum-SINR maximisation problem set out in Equations (6)-(9) as described below.

Since the sum-SINR maximisation problem can be classified as a Fractional programming (FP) problem (for example as described in “Fractional Programming for Communication Systems—Part I: Power Control and Beamforming” by Kaiming Shen and Wei Yu, arXiv:1802.10192), the quadratic transform (QT) proposed can be applied to this problem, yielding the following approximate problem:

$${maximize}_{η , 𝕘} {\sum }_{k = 1}^{K} \{ 2 R e [ {g}_{k}^{H} {A}_{k} ( η ) ] - {g}_{k}^{H} {B}_{k} ( η ) {g}_{k} \} \qquad ( 10 )$$

$$subject to {g}_{k} ∈ {ℂ}^{M \times 1} , {\vert {η}_{l} \vert}^{2} \leq {P}_{max} , for l = 1 , 2 , … , L \qquad ( 11 )$$

$$With :$$

$${A}_{k} ( η ) = {H}_{k} η \qquad ( 12 )$$

$${B}_{k} ( η ) = p {\sum }_{{i = 1}_{i \neq k}}^{K} ( {H}_{i} η {η}^{H} {H}_{i}^{H} + {H}_{i} η {\overline{h}}_{i}^{H} + {\overline{h}}_{i} {η}^{H} {H}_{i}^{H} ) \qquad ( 13 )$$

where [symbol] denotes a collection of auxiliary variables {g₁, . . . , g_{K}} introduced so as to approximate the sum-SINR function. Note that Aₖ and Bₖ are used instead of Âₖ and \hat{B}ₖ, since the constant terms with respect to η can be ignored. After some manipulation, the optimisation problem can be summarised as:

$$F ( η , 𝕘 ) = {max}_{η} \{ {η}^{H} C η + 2 R e [ D η ] \} , \qquad ( 14 )$$

$$subject to {g}_{k} ∈ {ℂ}^{M \times 1} , {\vert {η}_{l} \vert}^{2} \leq {P}_{max} , for l = 1 , 2 , … , L$$

where C and D is given by

$$C = - p {\sum }_{k = 1}^{K} {{\sum }_{i = 1}^{K}}_{i \neq k} {H}_{i}^{H} {ℊ}_{k} {ℊ}_{k}^{H} {H}_{i} ∈ {ℂ}^{L \times L} \qquad ( 15 )$$

$$D = {\sum }_{k = 1}^{K} ( {ℊ}_{k}^{H} {H}_{k} - p {{\sum }_{i = 1}^{K}}_{i \neq k} {\overline{h}}_{i}^{H} {ℊ}_{k} {ℊ}_{k}^{H} {H}_{i} ) ∈ {ℂ}^{1 \times L} . \qquad ( 16 )$$

F(η, [symbol] ) can be considered as a concave maximisation problem, and the following iterative approach can be applied to solve Equation (14). The iterative approach is also illustrated by FIG. 4.
401—The method is initiated/started.
403—Initialise the power and phase control vector η⁽⁰⁾ and set t=1.
405—Update [symbol] (t) by calculating

$${ℊ}_{k}^{( t )} = {\hat{B}}_{k}^{- 1} ( {η}^{( t - 1 )} ) {Â}_{k} ( {η}^{( t - 1 )} ) .$$

407—Update optimal η^{(t)} by Solving F(η^{(t)}, [symbol] ^{(t)}) for η^{(t)}.
409—Update t=t+1, and repeat 405-409 until an optimal η^{(t)} converges (that is, in step 409 it is determined whether η^{(t)} satisfies a certain stop condition for the iterative process, and if not, the method returns to step 405 to update [symbol] ^{(t)}). If η^{(t)} converges/the stop condition is satisfied, the method ends at step 411 (and the method continues at step 309 in which data uplink/downlink transmission proceeds using the weights in the optimal η^{(t)}).

It should be noted that the method applies straightforwardly in case only a fraction of the network repeaters 102 are currently subject to optimisation, and the remaining repeaters 102 are deactivated. This is achieved by defining Hₖ as Hₖ=[hₖ₁, . . . , h_{kL}], in which the columns corresponding to deactivated repeaters 102 are zero-padded. Thus, the techniques described herein can be seen as power and phase optimisation of a set of repeaters 102, i.e. the set of repeaters 102 that are chosen to be active.

As noted above, the above technique can be applied to either the uplink transmission direction or the downlink transmission direction. In either case, the channel information (e.g. CSI) can be determined based on UL reference signals or DL reference signals, on the assumption that the uplink and downlink transmission channels are reciprocal. That is, for the uplink transmission direction, uplink or downlink reference signals can be measured to provide the channel information for determining the repeater weights. Likewise, for the downlink transmission direction, uplink or downlink reference signals can be measured to provide the channel information for determining the repeater weights.

Furthermore, the disclosed methodology can be applied to multi-cell scenarios, where the sum of SINRs among all cells is jointly maximised under cross-cell interference (which is a type of interference that does not exist in single-cell systems). In such scenarios, the objective function shown in Equation (6) includes SINRs from other cells and the interference-plus-noise term in Equation (9) involves additional interference term(s) representing the interference signals from neighbouring cells. In spite of such changes, no change on the overall procedure described above is needed (with the exception of the addition of a step for inter-cell interference) and the same procedure can be still applied since it reduces down to the same optimisation class (i.e. a sum of fractions).

In cases where the disclosed methodology is applied to multi-cell scenarios, the results may be different from a single cell scenario, since the optimal amplification power may also take into account the possibility of strong interference towards neighbouring cells.

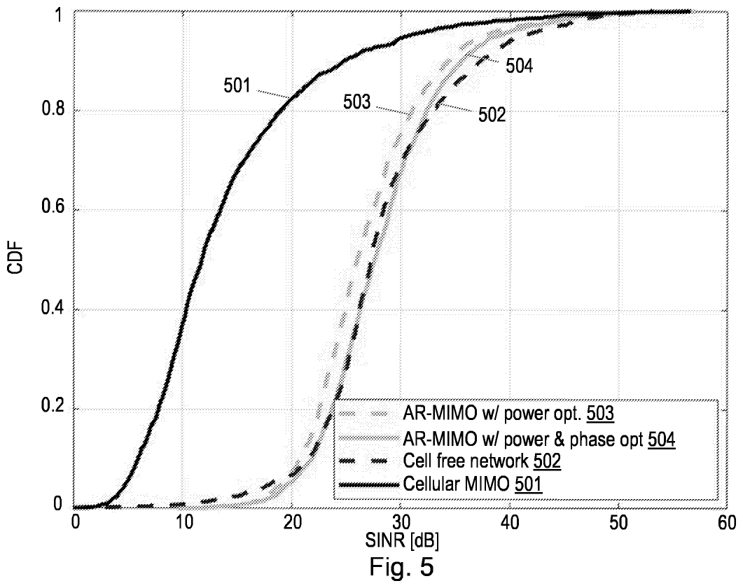

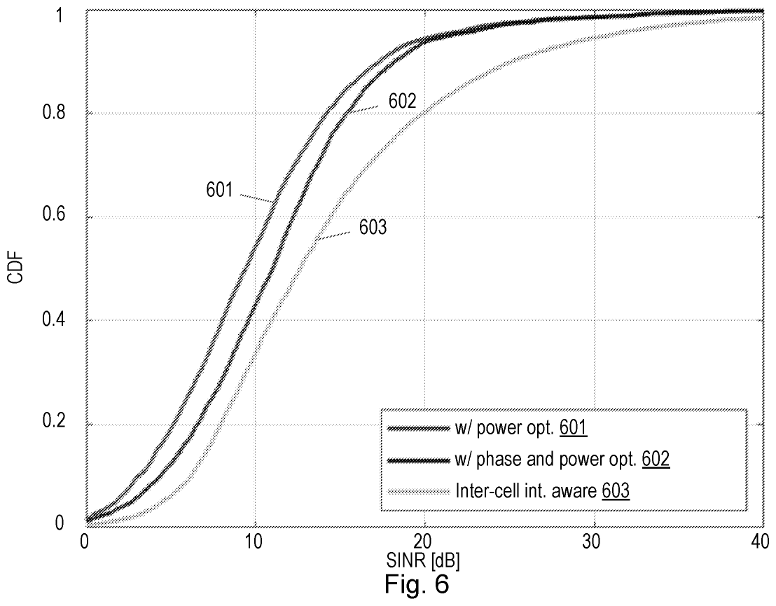

Various simulations have been performed to evidence the improvements provided by the techniques described above. Some of the simulation results are presented in the CDF vs SINR plots shown in FIGS. 5 and 6. In FIG. 5 the performance of repeater-assisted MIMO systems is compared with co-located massive MIMO and distributed massive MIMO (i.e., cell-free) systems, where each UE is served by only one massive MIMO array at the gNB in the co-located cellular scenario and is served by distributed access points (APs) in the distributed massive MIMO scenario. For the sake of simplicity, a single-cell scenario is assumed. As emphasised above, however, the disclosed methodology is not limited to a single-cell scenario. In what follows, the channel model used in the simulation is described, followed by a description of other simulation parameters.

For the channel modelling, the direct channel h̅ₖ between UE k and the BS 101 is modelled as:

$${\overline{h}}_{k} ∼ {𝒩}_{ℂ} ( {0}_{N} , {R}_{k} ) , \qquad ( 17 )$$

where Rₖ∈ [symbol] ^{N×N} is the covariance matrix that characterises the spatial correlation. When a Uniform Linear Array (ULA) which has M antennas are equally spaced by half-wavelength on a horizontal line is deployed at the BS 101, the (i, j)th element of Rₖ can be computed by following the local scattering model as:

$${[ {R}_{k} ]}_{i j} = {β}_{k} \int \int {e}^{j π ( i - j ) sin ( \overline{ϕ} ) cos ( \overline{θ} )} {f}_{k} ( \overline{φ} , \overline{θ} ) d \overline{φ} d \overline{θ} , \qquad ( 18 )$$

where βₖ is the path loss while φ̅ denotes the azimuth angle and θ̅ denotes the elevation angle of a multipath component. This scattering model is derived from “Foundations of User-Centric Cell-Free Massive MIMO” by Özlem Tuğfe Demir, Emil Björnson, Luca Sanguinetti, arXiv:2108.02541. As a probabilistic density function (PDF) of (18), the jointly Gaussian distribution is utilised:

$${f}_{k} ( \overline{φ} , \overline{θ} ) = \frac{1}{2 {πσ}_{φ} {σ}_{θ}} {e}^{- \frac{{( \overline{φ} - {φ}_{k} )}^{2}}{2 {σ}_{φ}^{2}}} {e}^{- \frac{{( \overline{θ} - {θ}_{k} )}^{2}}{2 {σ}_{θ}^{2}}} , \qquad ( 19 )$$

where φₖ and θₖ are the nominal azimuth and elevation angles of UE k.

Similarly, the channel

$${\overline{ℊ}}_{l}^{AB}$$

between repeater l and the BS 101 is generated as:

$${\overline{ℊ}}_{l}^{AB} ∼ {𝒩}_{ℂ} ( {0}_{N} , {R}_{l} ) . \qquad ( 20 )$$

The (i, j)th element of Rₗ is computed as

$${[ {R}_{l} ]}_{i j} = \int \int {e}^{j π ( i - j ) sin ( \overline{φ} ) cos ( \overline{θ} )} {f}_{l} ( \overline{φ} , \overline{θ} ) d \overline{φ} d \overline{θ} , \qquad ( 21 )$$

The PDF of (21) is given as the jointly Gaussian distribution:

$${f}_{l} ( \overline{φ} , \overline{θ} ) = \frac{1}{2 {πσ}_{φ} {σ}_{θ}} {e}^{- \frac{{( \overline{φ} - {φ}_{k} )}^{2}}{2 {σ}_{φ}^{2}}} {e}^{- \frac{{( \overline{θ} - {θ}_{k} )}^{2}}{2 {σ}_{θ}^{2}}} , \qquad ( 22 )$$

where φₗ and θₗ are the nominal azimuth and elevation angles of repeater l.

The channel between UE k and repeater l is assumed to be a Line-Of-Sight (LOS) channel, which is given by:

$${ℊ}_{k l}^{U A} = {w}_{k l} * {e}^{- \frac{j 2 π {d}_{k l}}{λ}} , \qquad ( 23 )$$

where λ, dₖₗ denote the wavelength of the carrier, the three-dimensional (3D) distance from UE k to repeater l, respectively. wₖₗ is the binary variable which indicates whether the channel between UE k and repeater l is LOS or not, and it is defined as follows:

$${w}_{k l} = \{ \begin{matrix}1 & if {d}_{kl}^{2 D} \leq 18 m \\ Bern ( x \vert Pr ( {d}_{kl}^{2 D} ) ) & if {d}_{kl}^{2 D} > 18 m\end{matrix} , \qquad ( 24 )$$

where

$$Bern ( x \vert Pr ( {d}_{kl}^{2 D} ) )$$

is a Bernoulli distribution of x∈{0,1} given by a LOS probability

$$Pr ( {d}_{k l}^{2 D} ) .$$

In 3GPP (for example 3GPP TS 38.901), the LOS probability in UMi-Street Canyon scenario is given as:

$$Pr ( {d}_{kl}^{2 D} ) = \{ \begin{matrix}1 & if {d}_{kl}^{2 D} \leq 18 m \\ \frac{18}{{d}_{kl}^{2 D}} + exp ( - \frac{{d}_{kl}^{2 D}}{36} ) ( 1 - \frac{18}{{d}_{kl}^{2 D}} ) & if {d}_{kl}^{2 D} > 18 m\end{matrix} . \qquad ( 25 )$$

Using (20) and (23), the indirect channel from UE k through repeater l to the BS is expressed as:

$${h}_{k l} = {β}_{k l} * {ℊ}_{k l}^{U A} * {\overline{ℊ}}_{l}^{A B} . \qquad ( 26 )$$

where βₖₗ is the total path loss from k-th UE to the BS via l-th repeater.

The SINR performance of AR-assisted MIMO in a single cell scenario is evaluated in comparison to the cellular MIMO system and the distributed MIMO system such as cell free network, where the SINR is computed by using the expression of Equation (5). The assumptions made here are as follows. The transmit power p is set to 10 dBm at UEs. The noise variance σ² is −96 dBm. Each element of η⁽⁰⁾ before the optimisation process is set to \sqrt{Pₘₐₓ}, and Pₘₐₓ=10 dBm. The pathloss of direct channel h̅ₖ is modeled by the 3GPP Urban Microcell model, for example as described in 3GPP TS 36.814. In contrast, the total pathloss of indirect channel hₖₗ is given by a free space pathloss model, for example as described in “Using Intelligent Reflecting Surfaces for Rank Improvement in MIMO Communications” by Özgecan Özdogan, Emil Björnson, and Erik G. Larsson, arXiv:2002.02182. It is assumed that the BS 101 has 64 antennas in ULA pattern and 8 UEs 103 are randomly distributed in a square service area with one-side length of 400 meters, and 64 repeaters 102 are equally distributed within the service area. Also, in this simulation setup, the repeaters 102 are activated based on the LOS probability.

The results are shown in FIG. 5, in which solid black line 501 indicates a typical cellular MIMO scenario without any repeater assistance; the black dashed line 502 corresponds to the cell free network (where the relevant simulation parameters and setups can be found in “Foundations of User-Centric Cell-Free Massive MIMO” referenced above). The grey dashed line 503 is the performance of the repeater-assisted MIMO scenario with power optimisation only, and the solid grey line 504 is the one with power and phase optimisation at the activated repeaters 102.

As shown in FIG. 5, the performances of repeater-assisted MIMO plotted by lines 503 and 504 outperform the traditional co-located scenario with the help of the distributed repeaters 102. Furthermore, the grey solid line 504 shows that the phase control can further improve the SINR gain thanks to additional degrees of freedom. More importantly, the disclosed methodology with repeater-assisted MIMO setup can result in a similar SINR performance compared to the cell-free setup. This indicates the possibility that D-MIMO-like performance can be obtained even without costly deployment of cabling between APs. Therefore, the disclosed methodology with repeater-assisted MIMO setup can be considered a reasonable alternative to a conventional D-MIMO architecture with wired fronthaul links.

Since a single cell scenario is considered in this performance assessment, the repeater-assisted MIMO scenario with power optimisation only shown by the grey dashed line 503 results in amplifying incoming signals with the maximum transmit power regardless of the position of repeaters (i.e. constant amplification). However, the optimal transmit power would be different in case of multi-cell scenarios, since amplifying with the maximum transmit power may cause strong interference towards neighbouring cells, resulting in degradation in the total SINR among all cells. The disclosed methodology covers both single-cell and multi-cell scenarios as described above.

To support the above, a SINR CDF comparison in case of a 2-cells scenario is shown in FIG. 6, where 2 cells located next to each other and the repeaters in 2 neighbouring cells are jointly optimised such that the inter-cell interference can be mitigated. The same procedure is utilised as set out above. Given the fact that the proposed scheme can yield a similar performance compared to D-MIMO with wired fronthaul links as shown in FIG. 5, the intention is to show that when taking such inter-cell interference into consideration, the optimum transmit power at the repeaters may not be equal to transmitting with full power. With that in mind, lines 601 and 602 in FIG. 6 respectively indicate scenarios where only power, and power and phase, are optimised at the repeaters 102 without considering inter-cell interference. In other words, the optimum η in case of the lines 601 and 602 corresponds to that in the single-cell scenario shown in FIG. 5 where there was no inter-cell interference. Therefore, such η may cause degradation in performance due to severe inter-cell interference. In contrast, the line 603 in FIG. 6 corresponds to the case where the inter-cell interference is taken into consideration when optimising η. As shown in FIG. 6, line 603 is shown to be superior to lines 601 and 602 in terms of achievable SINR.

In addition, it should be noted that the SINR achievable by the repeater-enhanced MIMO systems in FIG. 6 is shown to be lower than the one in FIG. 5, which is due to the inter-cell interference that was not taken into consideration in FIG. 5.

The following provides an outline of the methods described above. In particular, this disclosure provides methods for amplification power and/or phase control in repeater-assisted massive MIMO wireless communications systems, where multiple UEs simultaneously transmit uplink wireless signals to a common MIMO antenna array surrounded by repeaters. The method is carried out at the network side, for example in the RAN, or potentially in the core network. The method comprises obtaining channel state information between a common MIMO antenna array and repeaters as well as between repeaters and UEs; computing an optimal weight for each repeater based on the obtained channel information; applying, at each repeater, its associated computed weight; and receiving UL data signals from at least one UE, from one or more of the repeaters.

The channel state information may comprise or consist of channel gain, and/or phase information in the complex domain.

The step of computing a weight for each repeater can be composed of one or more sub-steps. In particular, an intractable utility function such as the sum of UEs' SINRs (e.g. Equations (6) and (7) above) can be transformed into a tractable function (e.g. Equation (14) above); repeaters' weights are updated such that the transformed utility function is maximised; the transformed utility function is updated for a given repeaters' weights; and if a certain convergence criterion is not yet triggered, the method returns to the earlier step where repeater weights are updated to maximise the transformed utility function.

In some embodiments, long-term statistics (e.g. spatial correlation) of the channel may be incorporated into the design. For example, long term statistics such as path losses and spatial correlation can be used in place of instantaneous CSI in the iterative process, if such instantaneous CSI of at least one channel is difficult to obtain.

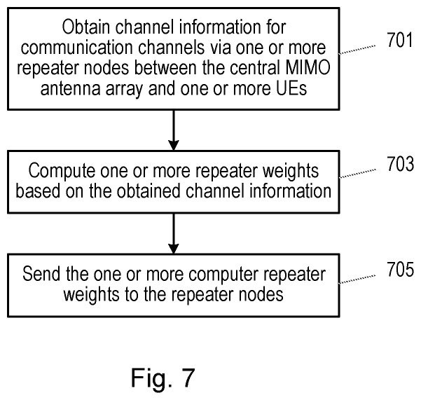

FIG. 7 is a flow chart illustrating a method of operating a first RAN node (e.g. BS/gNB 101) according to various embodiments. The first RAN node 101 may perform the method in response to executing suitably formulated computer readable code. The computer readable code may be embodied or stored on a computer readable medium, such as a memory chip, optical disc, or other storage medium. The computer readable medium may be part of a computer program product.

The first RAN node 101 comprises a central MIMO antenna array, and there are a plurality of (active) repeater nodes 102 in the communication network that can be used for repeating signals transmitted by the first RAN node 101, or for repeating signals transmitted by one or more UEs 103.

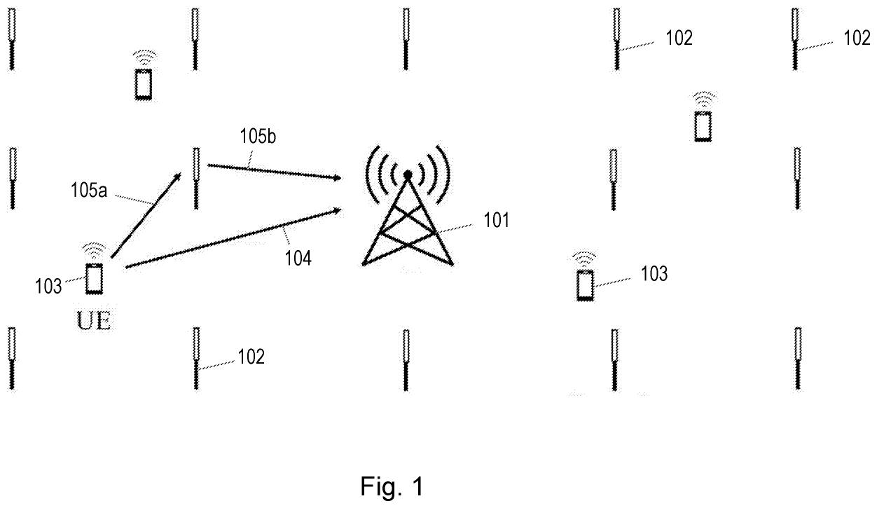

In step 701, channel information (e.g. channel state information (CSI)) is obtained for communication channels between the central MIMO antenna array/base station 101 and one or more UEs 103. One or more of these communication channels is via one or more of the repeater nodes 102 (e.g. channel 105a and 105b in FIG. 1). In some embodiments, channel information can also be obtained for a direct communication channel between the central MIMO antenna array and the one or more UEs 103. The channel information may comprise information on a gain of the communication channel and/or information on a phase of the communication channel.

The channel information may be obtained for uplink communication channels from the one or more UEs 103 and the central MIMO antenna array. In this case, channel information can be obtained by measuring one or more reference signals transmitted by the one or more UEs 103.

In addition or alternatively, the channel information may be obtained for downlink communication channels from the central MIMO antenna array to the one or more UEs 103. In this case, channel information can be obtained by receiving measurements of one or more reference signals transmitted by the first RAN node 101 from the one or more UEs 103.

In step 703, one or more repeater weights are computed based on the obtained channel information. A repeater weight is for adjusting a power and/or phase of signals repeated by one or more of the repeater nodes 102. A particular repeater weight can be used by a single repeater node 102, or it can be used by multiple repeater nodes 102.

The one or more repeater weights can be computed to optimise or improve a performance of communications between the first RAN node 101 and the one or more UEs 103.

In some embodiments, the one or more repeater weights can be computed to jointly optimise, for all of the one or more UEs 103 and/or for all of the one or more repeater nodes 102, a performance of communications between the first RAN node 101 and the one or more UEs 103.

In some embodiments, step 703 comprises forming a sum-parameter maximisation equation and computing the one or more repeater weights as the repeater weights that maximise the sum-parameter equation. Here, the parameter can be a measure of the performance of the communications between the first RAN node 101 and the one or more UEs 103. In some embodiments, the parameter is SNR or SINR.

In some embodiments, computing the one or more repeater weights is further based on interference from one or more neighbouring cells.

In step 705, the one or more computed repeater weights are sent to the repeater nodes 102.

The BS 101 can then communicate with a UE 103 via the one or more communication channels.

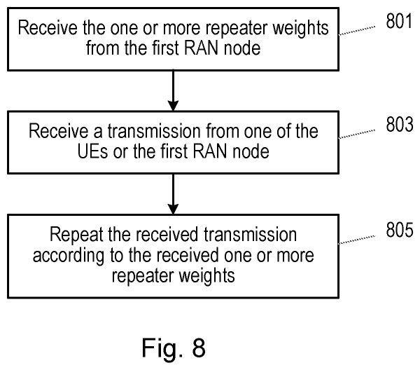

FIG. 8 is a flow chart illustrating a method of operating a repeater node 102 according to various embodiments. In a communication network, the method in FIG. 8 can be performed alongside or following the method in FIG. 7 by a RAN node 101. The repeater node 102 may perform the method in response to executing suitably formulated computer readable code. The computer readable code may be embodied or stored on a computer readable medium, such as a memory chip, optical disc, or other storage medium. The computer readable medium may be part of a computer program product.

The repeater node 102 is part of a communication network that comprises a first RAN node 101 and one or more UEs 103. The first RAN node 101 comprises a central MIMO antenna array, and the communication network comprises a plurality of repeater nodes 102 for the first RAN node 101. In step 801, the repeater node 102 receives one or more repeater weights from the first RAN node 101. The repeater weight(s) may have been determined as described above with respect to FIG. 7. In step 803, the repeater node 102 receives a transmission from one of the UEs 103 or the first RAN node 101. In step 805, the repeater node 102 repeats (i.e. transmits/sends) the received transmission according to the received one or more repeater weights. That is, where the repeater weight(s) relate to a power and/or phase of the signals repeated by the repeater node 102, the transmission power of the repeated signal is determined using the repeater weight (or the part of the repeater weight relating to transmission power) and/or the phase of the repeated signal is determined using the repeater weight (or the part of the repeater weight relating to phase).

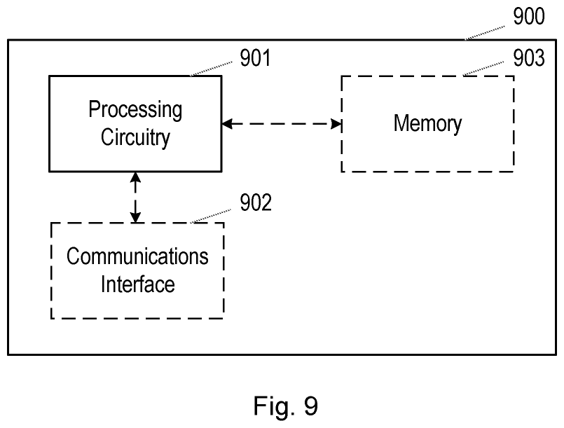

FIG. 9 is a simplified block diagram of an apparatus 900 according to some embodiments that can be used to implement one or more of the techniques described herein. The apparatus 900 may be, or be part of, a base station/gNB, or other type of RAN node, and may be configured to operate according to the methods described above and shown in any of FIG. 3, 4 or 7. Alternatively, the apparatus 900 may be, or be part of, a node in the core network of the communication network, and may be configured to operate according to the methods described above and shown in any of FIG. 3, 4 or 7. As another alternative, the apparatus 900 may be, or be part of, a repeater node in the RAN of the communication network, and may be configured to operate according to the methods described above and shown in FIG. 8.

FIG. 9 is a simplified block diagram of an apparatus 900 according to some embodiments that can be used to implement one or more of the techniques described herein. The apparatus 900 may be, or be part of, a base station/gNB, or other type of RAN node, and may be configured to operate according to the methods described above and shown in any of FIG. 3, 4 or 7. Alternatively, the apparatus 900 may be, or be part of, a node in the core network of the communication network, and may be configured to operate according to the methods described above and shown in any of FIG. 3, 4 or 7. As another alternative, the apparatus 900 may be, or be part of, a repeater node in the RAN of the communication network, and may be configured to operate according to the methods described above and shown in FIG. 8.

The apparatus 900 comprises processing circuitry (or logic) 901. It will be appreciated that the apparatus 900 may comprise one or more virtual machines running different software and/or processes. The apparatus 900 may therefore comprise, or be implemented in or as one or more servers, switches and/or storage devices and/or may comprise cloud computing infrastructure that runs the software and/or processes.

The processing circuitry 901 controls the operation of the apparatus 900 to implement the relevant part of the methods described herein. The processing circuitry 901 can comprise one or more processors, processing units, multi-core processors or modules that are configured or programmed to control the apparatus 900 in the manner described herein. In particular implementations, the processing circuitry 901 can comprise a plurality of software and/or hardware modules that are each configured to perform, or are for performing, individual or multiple steps of the method described herein in relation to the apparatus 900.

The apparatus 900 also comprises a communications interface 902. The communications interface 902 is for use in enabling communications with one or more of: UEs, other apparatus, other network nodes, computers, servers, etc. For example, the communications interface 902 can be configured to transmit to and/or receive from UEs, other RAN nodes or repeater nodes, requests, acknowledgements, information, data, signals, or similar. The communications interface 902 can use any suitable communication technology for the type of communications to be performed (e.g. using a suitable radio access technology (RAT) for communicating with a UE).

The processing circuitry 901 may be configured to control the communications interface 902 to transmit to and/or receive from UEs, other RAN nodes or repeater nodes, etc., requests, acknowledgements, information, data, signals, or similar, according to the methods described herein.

The apparatus 900 may comprise a memory 903. In some embodiments, the memory 903 can be configured to store program code that can be executed by the processing circuitry 901 to perform the methods described herein in relation to the apparatus 900. Alternatively or in addition, the memory 903 can be configured to store any requests, acknowledgements, information, data, signals, or similar that are described herein. The processing circuitry 901 may be configured to control the memory 903 to store such information therein.

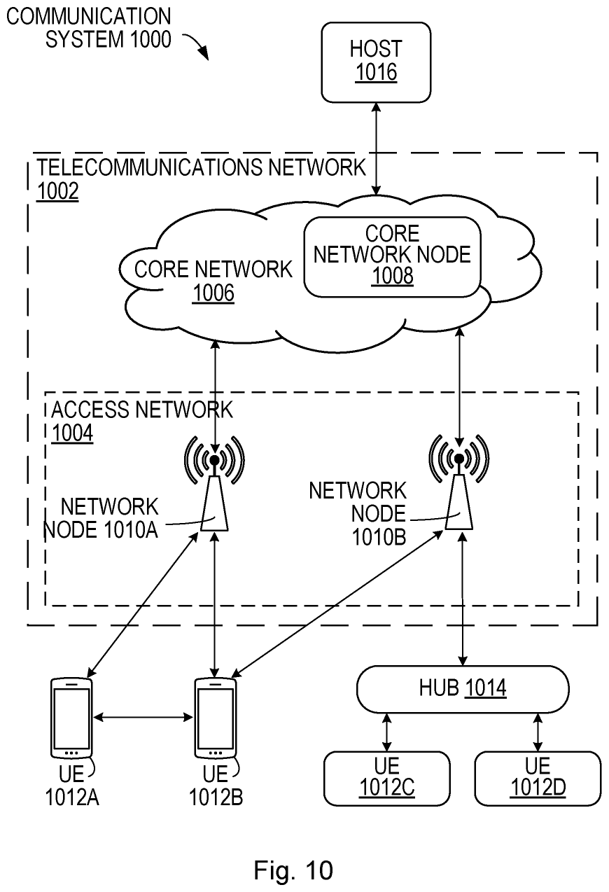

FIG. 10 shows an example of a communication system 1000 in accordance with some embodiments.

In the example, the communication system 1000 includes a communication network 1002 that includes an access network 1004, such as a radio access network (RAN), and a core network 1006, which includes one or more core network nodes 1008. The access network 1004 includes one or more access network nodes, such as access network nodes 1010a and 1010b (which are interchangeably referred to as RAN network nodes 1010 herein), or any other similar 3^{rd} Generation Partnership Project (3GPP) access node or non-3GPP access point (AP). Moreover, as will be appreciated by those of skill in the art, a RAN network node is not necessarily limited to an implementation in which a radio portion and a baseband portion are supplied and integrated by a single vendor. Thus, it will be understood that network nodes include disaggregated implementations or portions thereof. For example, in some embodiments, the communication network 1002 includes one or more Open-RAN (ORAN) network nodes. An ORAN network node is a node in the communication network 1002 that supports an ORAN specification (e.g., a specification published by the O-RAN Alliance, or any similar organization) and may operate alone or together with other nodes to implement one or more functionalities of any node in the communication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (RIC) (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies.

The access network nodes 1010 facilitate direct or indirect connection of wireless devices (also referred to interchangeably herein as user equipment (UE)), such as by connecting UEs 1012a, 1012b, 1012c, and 1012d (one or more of which may be generally referred to as UEs 1012) to the core network 1006 over one or more wireless connections. The access network nodes 1010 may be, for example, access points (APs) (e.g. radio access points), base stations (BSs) (e.g. radio base stations, Node Bs, evolved Node Bs (eNBs) and New Radio (NR) NodeBs (gNBs)).

Unless otherwise indicated, the general term ‘network node’ as used herein refers to access network nodes 1010 and core network nodes 1008.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The wireless devices/UEs 1012 may be any of a wide variety of communication devices, including wireless devices arranged, configured, and/or operable to communicate wirelessly with the network nodes 1010 and other communication devices. Similarly, the access network nodes 1010 are arranged, capable, configured, and/or operable to communicate directly or indirectly with the UEs 1012 and/or with other network nodes or equipment in the communication network 1002 to enable and/or provide network access, such as wireless network access, and/or to perform other functions, such as administration in the communication network 1002.

In the depicted example, the core network 1006 connects the access network nodes 1010 to one or more hosts, such as host 1016. These connections may be direct or indirect via one or more intermediary networks or devices. In other examples, network nodes may be directly coupled to hosts. The core network 1006 includes one more core network nodes (e.g. core network node 1008) that are structured with hardware and software components. Features of these components may be substantially similar to those described with respect to the wireless devices/UEs, access network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the communication network 1002, and may be operated by the service provider or on behalf of the service provider. The host 1016 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the wireless devices/UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2^{nd} Generation (2G), 3^{rd} Generation (3G), 4^{th} Generation (4G), 5^{th} Generation (5G) standards, or any applicable future generation standard (e.g. 6^{th} Generation (6G)); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the communication network 1002 is a cellular network that implements 3GPP standardized features. Accordingly, the communications network 1002 may support network slicing to provide different logical networks to different devices that are connected to the communication network 1002. For example, the communications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive Internet of Things (IoT) services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-radio access technology (RAT) or multi-standard mode. For example, a UE may operate with any one or combination of Wi-Fi, NR (New Radio) and LTE, i.e. being configured for multi-radio dual connectivity (MR-DC), such as E-UTRAN (Evolved-UTRA (UMTS Terrestrial Radio Access) Network) New Radio-Dual Connectivity (EN-DC).

In the example illustrated in FIG. 10, the hub 1014 communicates with the access network 1004 to facilitate indirect communication between one or more UEs (e.g. UE 1012c and/or 1012d) and access network nodes (e.g. access network node 1010b). In some examples, the hub 1014 may be a controller, router, a content source and analytics node, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a Virtual Reality VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy Internet of Things (IoT) devices.

The hub 1014 may have a constant/persistent or intermittent connection to the network node 1010b. The hub 1014 may also allow for a different communication scheme and/or schedule between the hub 1014 and UEs (e.g. UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to a Machine-to-Machine (M2M) service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

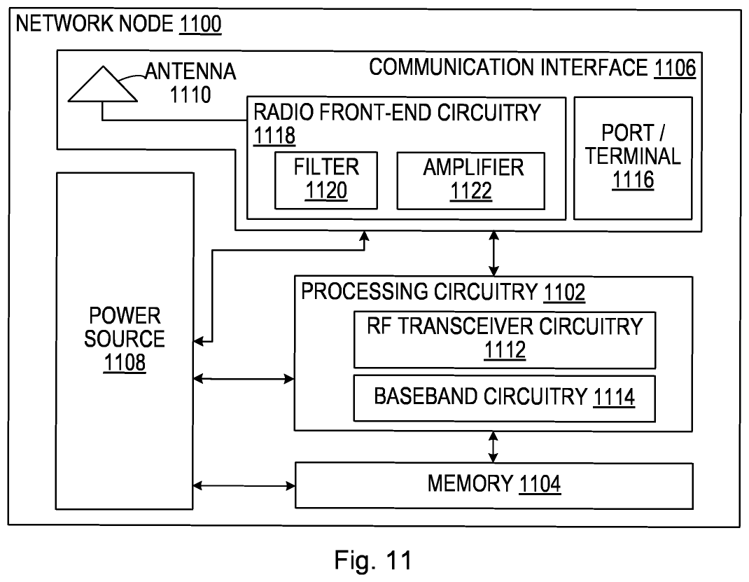

FIG. 11 shows an access network node 1100 or RAN network node 1100 in accordance with some embodiments.

As used herein, access network node or RAN network node refers to equipment capable, configured, arranged and/or operable to communicate directly or indirectly with a UE and/or with other RAN network nodes or equipment or core network nodes, in a communication network. Examples of access network nodes include, but are not limited to, access network nodes such as APs (e.g. radio access points), base stations (BSs) (e.g. radio base stations, Node Bs, evolved Node Bs (eNBs) and NR NodeBs (gNBs)), Open RAN (O-RAN) nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A RAN network node may also include one or more (or all) parts of a distributed radio base station such as centralized digital units, distributed units (e.g., in an O-RAN access node), and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of access network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g. Evolved Serving Mobile Location Centers (E-SMLCs)), and/or Minimization of Drive Tests (MDTs).

The RAN network node 1100 includes processing circuitry 1102, a memory 1104, a communication interface 1106, and a power source 1108, and/or any other component, or any combination thereof. The RAN network node 1100 may be composed of multiple physically separate components (e.g. a NodeB component and a RNC component, or a BTS component and a BSC component, etc.), which may each have their own respective components. In certain scenarios in which the RAN network node 1100 comprises multiple separate components (e.g. BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the RAN network node 1100 may be configured to support multiple radio access technologies (RATs). In such embodiments, some components may be duplicated (e.g. separate memory 1104 for different RATs) and some components may be reused (e.g. a same antenna 1110 may be shared by different RATs). The RAN network node 1100 may also include multiple sets of the various illustrated components for different wireless technologies integrated into RAN network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within RAN network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other RAN network node 1100 components, such as the memory 1104, to provide network node 1100 functionality. For example, the processing circuitry 1102 may be configured to cause the RAN network node to perform the methods as described with reference to any of FIG. 3, 4 or 7.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the RAN network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signalling and/or data between network nodes, the access network, the core network, and/or a UE. As illustrated, the communication interface 1106 comprises port(s)/terminal(s) 1116 to send and receive data, for example to and from a network over a wired connection.

The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the access network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the RAN network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of RAN network node 1100 in a form suitable for the respective components (e.g. at a voltage and current level needed for each respective component). The power source 1108 may further comprise, or be coupled to, power management circuitry to supply the components of the network node 1100 with power for performing the functionality described herein. For example, the RAN network node 1100 may be connectable to an external power source (e.g. the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the RAN network node 1100 may include additional components beyond those shown in FIG. 11 for providing certain aspects of the network node's functionality, including any of the functionality described herein and/or any functionality necessary to support the subject matter described herein. For example, the RAN network node 1100 may include user interface equipment to allow input of information into the RAN network node 1100 and to allow output of information from the RAN network node 1100. This may allow a user to perform diagnostic, maintenance, repair, and other administrative functions for the RAN network node 1100.

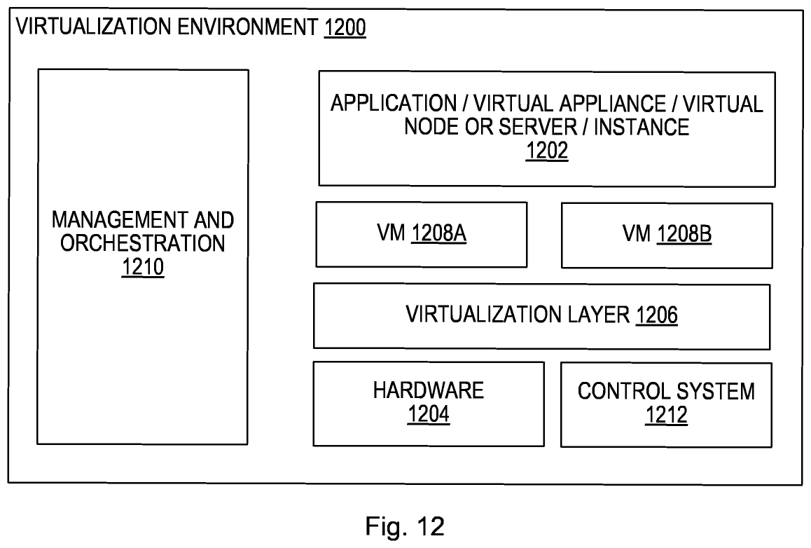

FIG. 12 is a block diagram illustrating a virtualization environment 1200 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as an access network node, a wireless device/UE, a core network node, or host. Further, in embodiments in which the virtual node does not require radio connectivity (e.g. a core network node or host), then the node may be entirely virtualized. In some embodiments, the virtualization environment 1200 includes components defined by the Open-RAN (O-RAN) Alliance, such as an O-Cloud environment orchestrated by a Service Management and Orchestration Framework via an O-2 interface.

Applications 1202 (which may alternatively be called software instances, virtual appliances, network functions, virtual nodes, virtual network functions, etc.) are run in the virtualization environment 1200 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system 1212 which may alternatively be used for communication between hardware nodes and radio units.

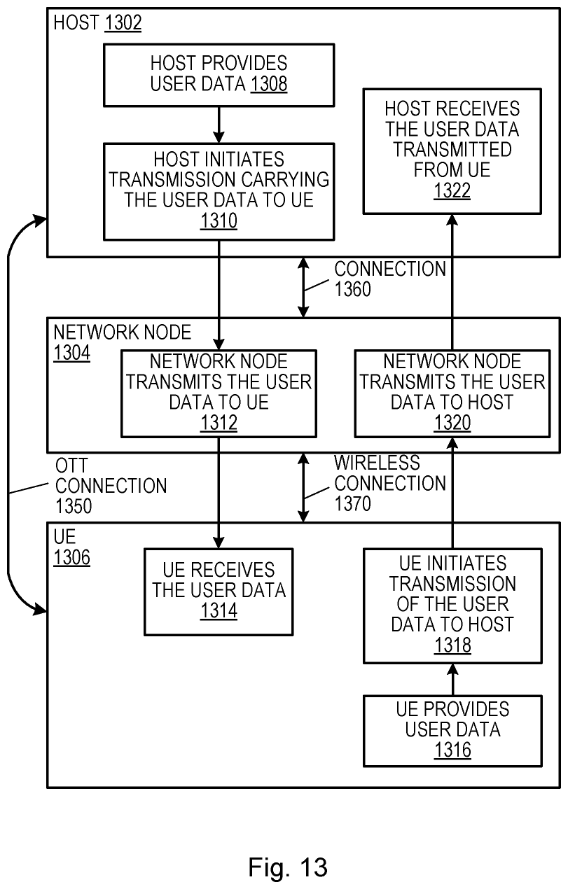

FIG. 13 shows a communication diagram of a host 1302 communicating via a network node 1304 with a UE 1306 over a partially wireless connection in accordance with some embodiments.

Example implementations, in accordance with various embodiments, of the UE (such as a UE 1012a of FIG. 10), access network node (such as RAN network node 1010a of FIG. 10 and/or RAN network node 1100 of FIG. 11), core network node QQ7, and host (such as host 1016 of FIG. 10) discussed in the preceding paragraphs will now be described with reference to FIG. 13.

Embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 1006 of FIG. 10) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the signal quality (and thus, e.g., the data rate, latency, etc.) for UL and/or DL communications, and thereby provide benefits such as, e.g. reduced user waiting time, improved content resolution, better responsiveness, etc.

In an example scenario, factory status information may be collected and analysed by the host 1302. As another example, the host 1302 may process audio and video data which may have been retrieved from a UE for use in creating maps. As another example, the host 1302 may collect and analyse real-time data to assist in controlling vehicle congestion (e.g. controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analysing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signalling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g. UEs, RAN network nodes, core network node, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

1. A method of operating a first radio access network (RAN) node in a communication network, wherein the first RAN node comprises a central multiple input/multiple output (MIMO) antenna array, and wherein the communication network comprises a plurality of repeater nodes for the first RAN node, the method comprising:
obtaining channel information for communication channels between the central MIMO antenna array and one or more user equipments (UEs), wherein one or more of the communication channels are via one or more of the repeater nodes;
computing one or more repeater weights based on the obtained channel information, wherein the repeater weight is for adjusting a power and/or phase of signals repeated by one or more of the repeater nodes; and
sending the one or more computed repeater weights to the repeater nodes.

2-16. (canceled)

17. A method of communicating between a first radio access network (RAN) node and one or more user equipments (UEs) wherein the first RAN node comprises a central multiple input/multiple output (MIMO) antenna array, and wherein the communication network comprises a plurality of repeater nodes for the first RAN node, the method comprising:
in operating the first RAN node;
obtaining channel information for communication channels between the central MIMO antenna array and one or more UEs, wherein one or more of the communication channels are via one or more of the repeater nodes;
computing one or more repeater weights based on the obtained channel information, wherein the repeater weight is for adjusting a power and/or phase of signals repeated by one or more of the repeater nodes; and
sending the one or more computed repeater weights to the repeater nodes, and
in a repeater node:
receiving the one or more repeater weights from the first RAN node;
receiving a transmission from one of the UEs or the first RAN node; and
repeating the received transmission according to the received one or more repeater weights.

18-37. (canceled)

38. A first radio access network (RAN) node for use in a communication network, wherein the first RAN node comprises a central multiple input/multiple output (MIMO) antenna array, and wherein the communication network comprises a plurality of repeater nodes for the first RAN node, the first RAN node comprising a processor and a memory, said memory containing instructions executable by said processor whereby said first RAN node is operative to:
obtain channel information for communication channels between the central MIMO antenna array and one or more UEs, wherein one or more of the communication channels are via one or more of the repeater nodes;
compute one or more repeater weights based on the obtained channel information, wherein the repeater weight is for adjusting a power and/or phase of signals repeated by one or more of the repeater nodes; and
send the one or more computed repeater weights to the repeater nodes.

39. The first RAN node as claimed in claim 38, further operative to communicate with a UE via the one or more communication channels.

40. The first RAN node as claimed in claim 38, wherein the first RAN node is further operative to obtain channel information for a direct communication channel between the central MIMO antenna array and the one or more UEs.

41. The first RAN node as claimed in claim 38, wherein the channel information is obtained for uplink communication channels from the one or more UEs and the central MIMO antenna array.

42. The first RAN node as claimed in claim 41, wherein the first RAN node is operative to obtain the channel information by measuring one or more reference signals transmitted by the one or more UEs.

43. The first RAN node as claimed in claim 38, wherein the channel information is obtained for downlink communication channels from the central MIMO antenna array to the one or more UEs.

44. The first RAN node as claimed in claim 43, wherein the first RAN node is operative to obtain the channel information by receiving, from the one or more UEs, measurements of one or more reference signals transmitted by the first RAN node.

45. The first RAN node as claimed in claim 38, wherein the channel information is channel state information.

46. The first RAN node as claimed in claim 38, wherein the channel information comprises information on a gain of the communication channel and/or information on a phase of the communication channel.

47. The first RAN node as claimed in claim 38, wherein the one or more repeater weights are computed to optimise a performance of communications between the first RAN node and the one or more UEs.

48. The first RAN node as claimed in claim 38, wherein the one or more repeater weights are computed to jointly optimise, for all of the one or more UEs and/or for all of the one or more repeater nodes, a performance of communications between the first RAN node and the one or more UEs.

49. A first RAN node as claimed in claim 38, wherein the first RAN node is operative to compute the one or more repeater weights by:
forming a sum-parameter maximisation equation, where the parameter is a measure of the performance of the communications between the first RAN node and the one or more UEs; and
computing the one or more repeater weights as the repeater weights that maximise the sum-parameter equation.

50. The first RAN node as claimed in claim 49, wherein the parameter is signal to noise ratio (SNR) or signal to interference plus noise ratio (SINR).

51. The first RAN node as claimed in claim 38, wherein the first RAN node is operative to compute one or more repeater weights further based on interference from one or more neighbouring cells.

52. The first RAN node as claimed in claim 38, wherein the first RAN node is further operative to:
receive user data from the one or more UEs; and
forward the user data to a host.

53. The first RAN node as claimed in claim 38, wherein the first RAN node is further operative to:
receive user data from a host; and
send the user data to one or more UEs.

54. A communication network comprising:
the first radio access network (RAN) node as claimed in claim 38;
one or more user equipments (UEs); and
a plurality of repeater nodes for the first RAN node.

55. A communication network as claimed in claim 54, wherein a repeater node is operative to:
receive the one or more repeater weights from the first RAN node;
receive a transmission from one of the UEs or the first RAN node; and
repeat the received transmission according to the received one or more repeater weights.
